(19) United States
(12) Patent Application Publication
(10) Pub. No.: US 2018/0082428 A1
(43) Pub. Date: Mar. 22, 2018

(54) USE OF MOTION INFORMATION IN VIDEO DATA TO TRACK FAST MOVING OBJECTS

(71) Applicant: QUALCOMM Incorporated, San Diego, CA (US)

(72) Inventors: Adrian Leung, Richmond Hill (CA); Alireza Shoa Hassani Lashdan, Burlington (CA); Darren Gnanapragasam, Aurora (CA)

(21) Appl. No.: 15/267,944

(22) Filed: Sep. 16, 2016

(51) Int. Cl. G06T 7/20; G06T 7/00

(52) U.S. Cl. CPC G06T 7/2006; G06T 7/0081; G06T 2207/20012; G06T 2207/20021; G06T 2207/10016

(57) ABSTRACT

A system comprising one or more storage devices configured to store data representing a video sequence, and one or more processors. The storage device(s) store instructions that, when executed, cause the at least one processor to: determine a region of interest for an object in a video frame of a video sequence, determine motion information between the video frame and a later video frame of the video sequence, determine, based on the region of interest and the motion information, an adjusted region of interest in the later video frame, and apply a mean shift algorithm to identify, based on the adjusted region of interest, the object in the later video frame.

### TECHNICAL FIELD

This disclosure relates to video processing, and more particularly, to tracking objects in video frames of a video sequence.

### BACKGROUND

Video-based object tracking is the process of identifying a moving object within video frames of a video sequence. Often, the objective of object tracking is to associate objects in consecutive video frames. Object tracking may involve determining a region of interest (ROI) within a video frame containing the object. Tracking objects that are moving very quickly, such as a ball in a video depicting sports activities, is difficult. Some ROI tracking algorithms have a tendency to fail when the object to be tracked moves too quickly.

### SUMMARY

This disclosure is directed to techniques that include modifying, adjusting, or enhancing one or more object tracking algorithms, as well as methods, devices, and techniques for performing such object tracking algorithms, so that such algorithms more effectively track fast-moving objects. In some examples, techniques are described that include using motion information to enhance one or more object tracking algorithms. For example, CAMShift algorithms are fast and efficient algorithms for tracking objects in a video sequence. CAMShift algorithms tend to perform well when tracking objects that are moving slowly, but such CAMShift algorithms may be less effective when tracking objects that are moving quickly. In accordance with one or more aspects of the present disclosure, a video processing system may incorporate motion information into a CAMShift (Continuously Adaptive Mean Shift) algorithm. In some examples, the motion information is used to adjust a region of interest used by a CAMShift algorithm to identify or track an object in a video frame of a video sequence. A video processing system implementing a CAMShift algorithm that is enhanced with such motion information may more effectively track fast-moving objects.

In some examples, a video processing system may determine analytic information relating to one or more tracked objects. Analytic information as determined by the video processing system may include the trajectory, velocity, distance, or other information about the object being tracked. Such analytic information may be used, for example, to analyze a golf or baseball swing, a throwing motion, swimming or running form, or other instances of motion present in video frames of a video sequence. In some examples, a video processing system may modify video frames of a video sequence to include analytic information and/or other information about the motion of objects. For example, a video processing system may modify video frames to include graphics illustrating the trajectory, velocity, or distance traveled by a ball, or may include text, audio, or other information describing or illustrating trajectory, velocity, distance, or other information about one or more objects being tracked.

In one example of the disclosure, a method comprises: determining a region of interest for an object in a first video frame of a video sequence; determining motion information indicating motion between at least a portion of the first video frame and at least a portion of a second video frame of the video sequence; determining, based on the region of interest and the motion information, an adjusted region of interest in the second video frame; and applying a mean shift algorithm to identify, based on the adjusted region of interest, the object in the second video frame.

In another example of the disclosure, a system comprises: at least one processor; and at least one storage device. The at least one storage device stores instructions that, when executed, cause the at least one processor to: determine a region of interest for an object in a first video frame of a video sequence, determine motion information between the video frame and a later video frame of the video sequence, determine, based on the region of interest and the motion information, an adjusted region of interest in the later video frame, and apply a mean shift algorithm to identify, based on the adjusted region of interest, the object in the later video frame.

In another example of the disclosure, a computer-readable storage medium comprises instructions that, when executed, cause at least one processor of a computing system to: determine a region of interest for an object in a first video frame of a video sequence; determine motion information between the video frame and a later video frame of the video sequence; determine, based on the region of interest and the motion information, an adjusted region of interest in the later video frame; and apply a mean shift algorithm to identify, based on the adjusted region of interest, the object in the later video frame.

### BRIEF DESCRIPTION OF THE DRAWINGS

FIG. 1 is a conceptual diagram illustrating an example video processing system that is configured to track an object in video frames of a video sequence in accordance with one or more aspects of the present disclosure.

FIG. 2A is a conceptual diagram illustrating consecutive video frames of a video sequence, where an example object tracking system uses a CAMShift algorithm to track a relatively slow object.

FIG. 2B is a conceptual diagram illustrating consecutive video frames of a video sequence, where an example object tracking system uses a CAMShift algorithm to track a relatively fast object.

FIG. 3 is a block diagram illustrating an example computing system that is configured to track an object in video frames of a video sequence in accordance with one or more aspects of the present disclosure.

FIG. 4A, FIG. 4B, FIG. 4C, and FIG. 4D are conceptual diagrams illustrating example video frames of a video sequence, where a relatively fast object is tracked in accordance with one or more aspects of the present disclosure.

FIG. 5A, FIG. 5B, and FIG. 5C are conceptual diagrams illustrating example video frames of a video sequence, where a relatively fast object is tracked in a different example in accordance with one or more aspects of the present disclosure.

FIG. 6 is a flow diagram illustrating operations performed by an example computing system in accordance with one or more aspects of the present disclosure.

FIG. 7 is a flow diagram illustrating an example process for performing object tracking in accordance with one or more aspects of the present disclosure.

### DETAILED DESCRIPTION

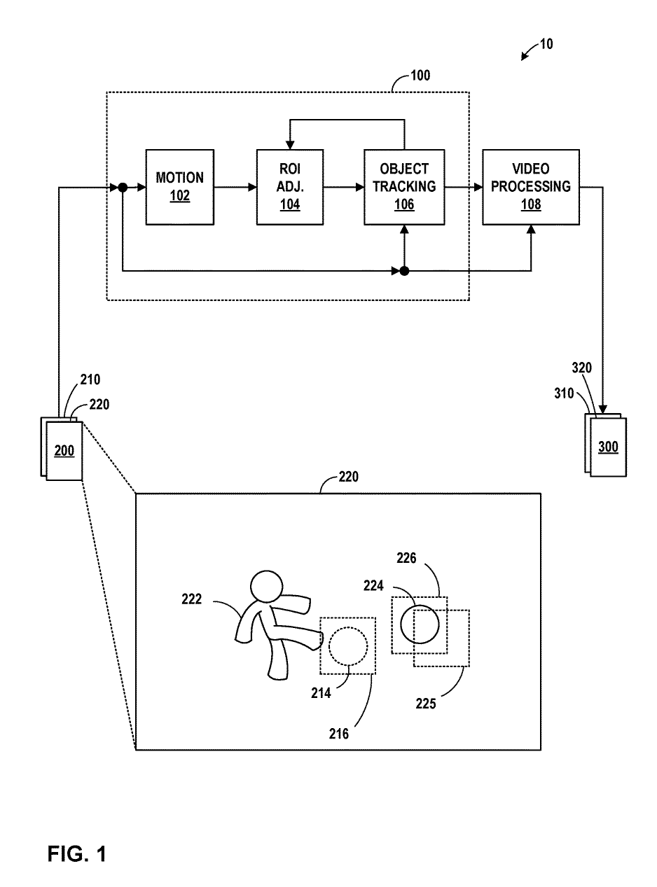

FIG. 1 is a conceptual diagram illustrating an example video processing system that is configured to track an object in video frames of a video sequence in accordance with one or more aspects of the present disclosure. Video processing system 10, in the example of FIG. 1, includes ROI processor 100 and video processing circuitry 108. Video processing system 10 receives input video frames 200 (including video frame 210 and video frame 220), and generates output video frames 300 (including video frame 310 and video frame 320). ROI processor 100 may include motion estimation circuitry 102, ROI adjustment circuitry 104, and object tracking circuitry 106.

Input video frames 200 may include many frames of a video sequence. Video frame 210 and video frame 220 are consecutive frames within input video frames 200. In the example shown, video frame 220 follows video frame 210 in display order. As further described below, video frame 220 shown in FIG. 1 includes soccer player 222, ball 224, prior position of ball 214. A number of ROIs are also illustrated in video frame 220, including ROI 216, ROI 226, and adjusted ROI 225.

In some examples, input video frames 200 may be video frames from a video sequence generated by a camera or other video capture device. In other examples, input video frames 200 may be video frames from a video sequence generated by a computing device, generated by computer graphics hardware or software, or generated by a computer animation system. In further examples, input video frames 200 may include pixel-based video frames obtained directly from a camera or from a video sequence stored on a storage device. Input video frames 200 may include video frames obtained by decoding frames that were encoded using a video compression algorithm, which may adhere to a video compression standard such as H.264 or H.265, for example. Other sources for input video frames 200 are possible.

As further described below, motion estimation circuitry 102 may determine motion between consecutive or other input video frames 200. ROI adjustment circuitry 104 may adjust the location of a ROI in one or more input video frames 200 in accordance with one or more aspects of the present disclosure. Object tracking circuitry 106 may track one or more objects in input video frames 200, based on input video frames 200 and input from ROI adjustment circuitry 104. Video processing circuitry 108 may process input video frames 200 and/or input from ROI processor 100. For example, video processing circuitry 108 may determine information about one or more objects tracked in input video frames 200 based at least in part on input from ROI processor 100. Video processing circuitry 108 may modify input video frames 200 and generate output video frames 300. Included in output video frames 300 are video frame 310 and video frame 320, with video frame 320 following video frame 310 consecutively in display order. Video frame 310 and video frame 320 may generally correspond to video frame 210 and video frame 220 after processing and/or modification by video processing circuitry 108.

Motion estimation circuitry 102, ROI adjustment circuitry 104, object tracking circuitry 106, and/or video processing circuitry 108 may perform operations described in accordance with one or more aspects of the present disclosure using hardware, software, firmware, or a mixture of hardware, software, and/or firmware. In one or more of such examples, one or more of motion estimation circuitry 102, ROI adjustment circuitry 104, object tracking circuitry 106, and video processing circuitry 108 may include one or more processors or other equivalent integrated or discrete logic circuitry. In other examples, motion estimation circuitry 102, ROI adjustment circuitry 104, object tracking circuitry 106, and/or video processing circuitry 108 may be fully implemented as fixed function circuitry in hardware in one or more devices or logic elements. Further, although one or more of motion estimation circuitry 102, ROI adjustment circuitry 104, object tracking circuitry 106, and video processing circuitry 108 have been illustrated separately, one or more of such items could be combined and operate as a single integrated circuit or device, component, module, or functional unit. Further, one or more or all of motion estimation circuitry 102, ROI adjustment circuitry 104, object tracking circuitry 106, and video processing circuitry 108 may be implemented as software executing on a general purpose hardware or computer environment.

Object tracking circuitry 106 may implement, utilize, and/or employ a mean shift algorithm to track objects within input video frames 220. In some examples, when object tracking circuitry 106 applies a mean shift algorithm, object tracking circuitry 106 generates a color histogram of the initial ROI identifying the object to be tracked in a first video frame of a video sequence. In the next frame (i.e., the second frame), in some examples, object tracking circuitry 106 generates a probability density function based on the color information (e.g., saturation, hue, and/or other information) from the ROI of the first frame, and iterates using a recursive mean shift process until it achieves maximum probability, or until it restores the distribution to the optimum position in the second frame. A mean shift algorithm is a procedure used to find the local maxima of a probability density function. A mean shift algorithm is iterative in that the current window position (e.g., ROI) is shifted by the calculated mean of the data points within the window itself until the maxima is reached. This shifting procedure can be used in object tracking when a probability density function is generated based on a video frame raster. By using the color histogram of the initial ROI identifying the object on the first video frame, each pixel in the current frame raster can be assigned a probability of whether it is a part of the object. This procedure of assigning probabilities is called back projection and produces the probability distribution on the video frame raster which is suitable input to the mean shift algorithm. Given that object tracking circuitry 106 has access to the ROI position from the previous frame, and the object from that ROI did not totally move outside of it on the current frame, the mean shift algorithm applied by the object tracking circuitry 106 will iteratively move to the local maxima of the probability distribution function. In some examples, the maxima is likely the new position of the object. In cases where the object has moved outside of the ROI, the mean calculation performed by object tracking circuitry 106 within the current window might not trend towards the correct local maxima (new position of the object), simply because those pixel probabilities are not included in the mean calculation. See, e.g., K. Fukunaga and L. D. Hostetler, “The Estimation of the Gradient of a Density Function, with Applications in Pattern Recognition,” IEEE Trans. Information Theory, vol. 21, pp. 32-40 (1975).

In the example illustrated in FIG. 1, object tracking circuitry 106 detects the object in the second frame by using information about the first frame ROI (e.g., the information may include the position, shape, or location of the ROI from the first frame).

A CAMShift algorithm operates in a manner similar to a mean shift algorithm, but builds upon mean shift algorithms by also varying the ROI size to reach convergence or maximum probability. The varying ROI size helps to resize the bounded region of the ROI to follow size changes to the object itself.

CAMShift algorithms are generally effective at tracking relatively slowly moving objects, i.e., slow objects, but CAMShift algorithms tend to be less effective at tracking relatively fast moving objects, i.e., fast objects. In general, a CAMShift algorithm is able to track objects effectively when the motion of the object between frames, measured as a distance, is no larger than the size of the object itself, or if the object being tracked does not move completely out of the prior frame ROI (i.e., the ROI in the immediately prior frame). For example, if the object in a subsequent frame has moved completely outside of the ROI of the object from a prior frame (in terms of x,y coordinates) so that the new position of the object has no overlap with the position of the ROI in the prior frame, then the movement of the object between frames may be considered to have moved a distance greater (again, in terms of x,y coordinates) than the size of the object in terms of x,y coordinates.

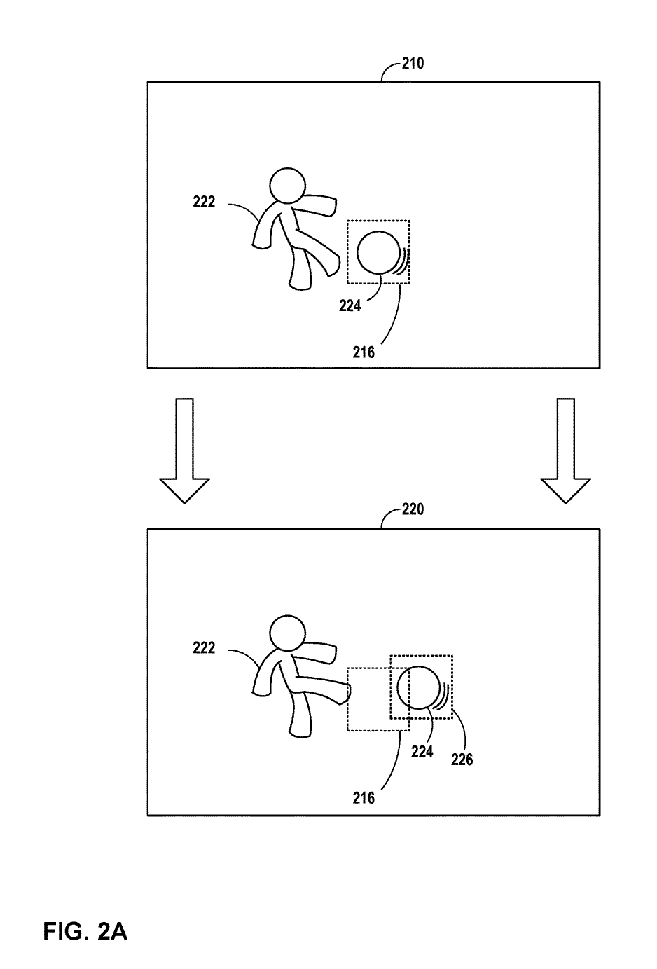

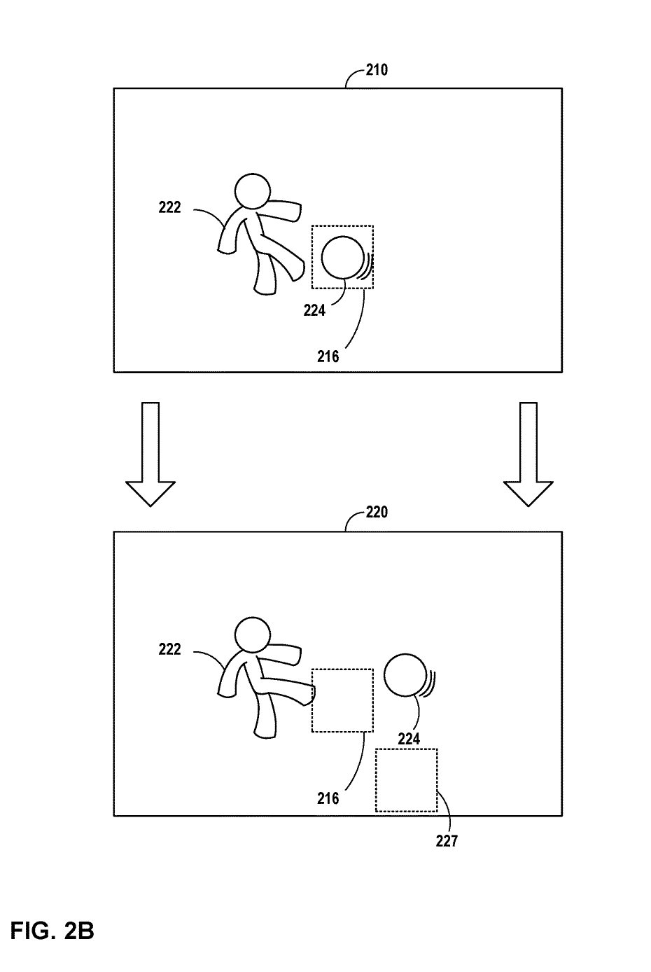

Fast-moving objects have a tendency to exhibit a large amount of movement, resulting in the object moving, in a current frame, outside of the ROI specified for the object in a prior frame. Accordingly, CAMShift algorithms may not be as effective in tracking fast-moving objects. To further illustrate, FIG. 2A and FIG. 2B each depict different situations in which objects are tracked by a CAMShift algorithm.

FIG. 2A is a conceptual diagram illustrating consecutive video frames of a video sequence, where an example object tracking system uses a CAMShift algorithm to track a relatively slow object. In the example of FIG. 2A, video frame 210 and video frame 220 are shown, both illustrating soccer player 222 having kicked ball 224, and in the video frame 210 and video frame 220, ball 224 is moving away from soccer player 222. Within input video frames 200, video frame 220 may be a frame that immediately follows video frame 210 in display order. In some examples, video frame 220 may be a frame that follows frame 210 in display order, but does not necessarily immediately follow video frame 210, e.g., the case in which a CAMShift algorithm operates on a temporally sub-sampled set of input frames.

In video frame 210 of FIG. 2A, it is assumed that object tracking circuitry 106 (or another device, component, module, or system implementing a CAMShift algorithm) has determined ROI 216 in video frame 210, wherein ROI 216 may be the location within video frame 210 where the object to be tracked is located. Object tracking circuitry 106 may then attempt to track the new location of ball 224 in video frame 220. To do so, object tracking circuitry 106 evaluates information about ROI 216 in video frame 210, and object tracking circuitry 106 may determine a color distribution and/or a color histogram for ROI 216 in video frame 210. Based on this information, object tracking circuitry 106 may attempt to determine the new location of ball 224 in video frame 220 by searching for a region in video frame 200 that presents a sufficiently matching distribution of color pixel samples in video frame 220. Because of the way that CAMShift algorithms are implemented, as previously described, mean shift or CAMShift algorithms may generally be more effective when the object being tracked in video frame 220 (i.e., ball 224) at least partially overlaps the ROI of the earlier frame (i.e., in this case, ROI 216). This is due to the use of a probability distribution and the iterative approach of CAMShift algorithms. The probability distribution for the video frame 220 is generated by using the color histogram for ROI 216 in video frame 210. It is therefore a probability map of the new location of the object on video frame 220. In order to find the most probable position of the object, however, CAMShift algorithms require partial overlap of the object (i.e. ball 224 in video frame 220) to ROI 216. As long as there is partial overlap, a CAMShift algorithm will iteratively mean shift the position of the ROI (using the probability information within the ROI itself) towards the increasing probability and eventually converge on the maxima. Without overlap, a CAMShift algorithm will not necessarily move in the correct direction because the results of the mean shift within the ROI won't necessary be in the direction of increasing probability since there was no overlap. In the example of FIG. 2A, since ball 224 has not moved completely out of ROI 216 in video frame 220, object tracking circuitry 106 may, in some or most cases, be able to detect ball 224 in video frame 220 and accurately determine a new ROI 226, correctly identifying the new location of ball 224 in video frame 220.

FIG. 2B is a conceptual diagram illustrating consecutive video frames of a video sequence, where an example object tracking system uses a CAMShift algorithm to track a relatively fast object. In the example of FIG. 2B, video frame 210 and video frame 220 are shown, both illustrating soccer player 222 having kicked ball 224, and like FIG. 2A, video frame 220 follows video frame 210, e.g., immediately, in FIG. 2B. In the example of FIG. 2B, object tracking circuitry 106 (or another device) determines ROI 216. As shown in FIG. 2B, ROI 216 includes ball 224, the object being tracked, in video frame 210. In FIG. 2B, object tracking circuitry 106 may attempt to track the new location of ball 224 in video frame 220 by evaluating information about ROI 216 in video frame 210. In the example of FIG. 2B, ball 224 is moving faster than in the example of FIG. 2A, and in FIG. 2B, ball 224 has moved completely out of ROI 216 in video frame 220. Accordingly, an object tracking system that implements a CAMShift algorithm without any enhancements may be unable to detect ball 224 in video frame 220 in some or most cases, which may prompt or require redetection of the object. When a CAMShift algorithm begins the iterative mean shift of ROI 216 in video frame 210, it will calculate the mean of the probability data within ROI 216. Since there was no overlap with ball 224, the mean calculation will not trend towards the position of ball 224 (because there was no overlap) and thus no increasing probability towards the position of ball 224. In some examples, an unenhanced CAMShift algorithm may determine ROI 227, but ROI 227 does not correctly identify ball 224. Therefore, in the example of FIG. 2B, the CAMShift algorithm fails to properly track or identify ball 224 in video frame 220.

Referring again to FIG. 1, in some examples in accordance with the techniques of this disclosure, ROI processor 100 uses motion estimation circuitry 102 and ROI adjustment circuitry 104 to enhance a CAMShift algorithm implemented by object tracking circuitry 106 so that the CAMShift algorithm can be used effectively for tracking fast-moving objects. In the example shown in FIG. 1, ROI processor 100 tracks ball 224 from prior video frame 210 to immediately subsequent video frame 220. In prior video frame 210, ROI processor 100 has successfully identified ball 224 and determined ROI 216. The position of ROI 216 (from video frame 210) is shown in video frame 220 of FIG. 1. Illustrated within ROI 216 of FIG. 1 is the prior position 214 of ball 224.

To detect ball 224 in video frame 220, motion estimation circuitry 102 of ROI processor 100 may detect input in the form of one or more input video frames 200, including video frame 220. Motion estimation circuitry 102 may determine, based on information from video frame 210 and video frame 220, motion information. Such motion information may take the form of one or more motion vectors. In some examples, motion estimation circuitry 102 may be specialized hardware that measures motion information between two or more frames, such as a frame-by-frame motion estimation system or device. In other examples, object tracking circuitry 106 may include a video encoder, logic from a video encoder, or other device that determines motion information and/or motion vectors. Other methods for determining motion information between video frame 210 and video frame 220 are possible and contemplated, and may be used in accordance with one or more aspects of the present disclosure. Although generally described in the context of estimating motion between two frames, techniques in accordance with one or more aspects of the present disclosure may also be applicable to motion determined between three or more frames.

Motion estimation circuitry 102 may output to ROI adjustment circuitry 104 information sufficient to determine motion information, such as motion vectors, between an object in video frame 210 and the object in video frame 220. ROI adjustment circuitry 104 may determine, based on the motion information from motion estimation circuitry 102 and information about ROI 216 from prior video frame 210, an adjusted ROI. Specifically, in some examples, ROI adjustment circuitry 104 may determine adjusted ROI 225 based on the motion information from motion estimation circuitry 102 and information about ROI 216 from prior video frame 210. Such motion information may include the direction and/or magnitude of motion, and information about ROI 216 may include information sufficient to determine the location, dimensions, and/or x,y coordinates of ROI 216. ROI adjustment circuitry 104 may receive ROI information as input from object tracking circuitry 106. In some examples, since object tracking circuitry 106 may have already processed prior video frame 210, ROI adjustment circuitry 104 may receive information about ROI 216 from prior video frame 210 as input from object tracking circuitry 106.

ROI adjustment circuitry 104 may output information about adjusted ROI 225 to object tracking circuitry 106. Object tracking circuitry 106 may use a CAMShift algorithm to attempt to detect or track ball 224 in video frame 220, but rather than using ROI 216 as a starting ROI for detecting ball 224, which may be the manner in which CAMShift algorithms normally operate, object tracking circuitry 106 instead uses adjusted ROI 225. In the example of video frame 220 illustrated in FIG. 1, ball 224 does not overlap ROI 216. As a result, a CAMShift algorithm might not be effective in tracking ball 224 if ROI 216 is used at a starting ROI for tracking ball 224. However, if object tracking circuitry 106 uses adjusted ROI 225 as a starting ROI for tracking ball 224, the CAMShift algorithm implemented by object tracking circuitry 106 may successfully track ball 224, since ball 224 overlaps adjusted ROI 225. In the example shown in FIG. 1, object tracking circuitry 106 determines ROI 226, properly identifying the location of ball 224. Accordingly, ROI processor 100 may enable effective use of the CAMShift algorithm to track fast-moving objects by using motion information, such as motion vectors. As described, prior to running the CAMShift algorithm, 100 may analyze motion vectors of blocks of video data bounded by the ROI in the previous frame. Using this data, ROI processor 100 may move the ROI to a new position that should overlap the location of the object on the current video frame. ROI processor 100 may then perform a CAMShift algorithm to determine the location of the object.

Object tracking circuitry 106 may output information about ROI 226 to video processing circuitry 108. Video processing circuitry 108 may determine information about video frame 220 and video frame 210 based on input video frames 200 and the information about ROI 226 received from object tracking circuitry 106. In some examples, video processing circuitry 108 may determine analytic information about the movement of ball 224, which may include information about the distance traveled by ball 224 or information about the trajectory and/or velocity of ball 224. In some examples, video processing circuitry 108 may modify input video frames 200 to include, within one or more video frames, analytic information about the movement of ball 224, which may include information about the distance traveled by ball 224 or information about the trajectory and/or velocity of ball 224. For example, video processing circuitry 108 may generate one or more output video frames 300 in which an arc is drawn to show the trajectory of ball 224. Alternatively, or in addition, video processing circuitry 108 may generate one or more output video frames 300 that include information about the velocity of ball 224. By tracking an object, video processing circuitry 108 has access to the distance in pixels travelled by the object from the start and end position of the ball 224. Video processing circuitry 108 also knows the size of the object in pixels at both the start and end position. Based on knowledge of the object being tracked (i.e. the user provides the object type a priori or through object classification via computer vision techniques), video processing circuitry 108 may determine a reference size of the object. Video processing circuitry 108 may generate a system of equations where the only unknown is the estimated distance travelled, and therefore determine the estimated distance travelled. In a video sequence, video processing circuitry 108 may access information about the frame rate of the sequence, and may use this information, combined with the distance travelled, to calculate a velocity. Video processing circuitry 108 may also estimate the maximum velocity by measuring the distance travelled between segments of a frame sequence and finding the maximum.

In examples described herein, the ROI is shown as a rectangle or square for purposes of clarity and illustration. However, the ROI may take other forms or shapes, and in some examples, the shape of the ROI may in at least some respects mirror the shape of the object being tracked. Further, a device may change the size and/or shape of the ROI from frame to frame.

When tracking an object in a video sequence, particularly a fast-moving object, failure to detect the ROI in a sequence of video frames may require redetection of the object in the video sequence. Redetection may be a computationally expensive process, and may consume additional resources of video processing system 10 and/or ROI processor 100. By using motion information to adjust the position of the prior frame ROI in a video sequence, ROI processor 100 may more effectively track fast-moving objects, and reduce instances of redetection. By performing less redetection operations, ROI processor 100 may perform less operations, and as a result, consume less electrical power.

Further, by using motion information to enhance a CAMShift algorithm, ROI processor 100 may be able to effectively track fast-moving objects in a video sequence using a CAMShift algorithm, thereby taking advantage of beneficial attributes of CAMShift algorithms (e.g., speed and efficiency) while overcoming a limitation of CAMShift algorithms (e.g., limited ability to track fast-moving objects).

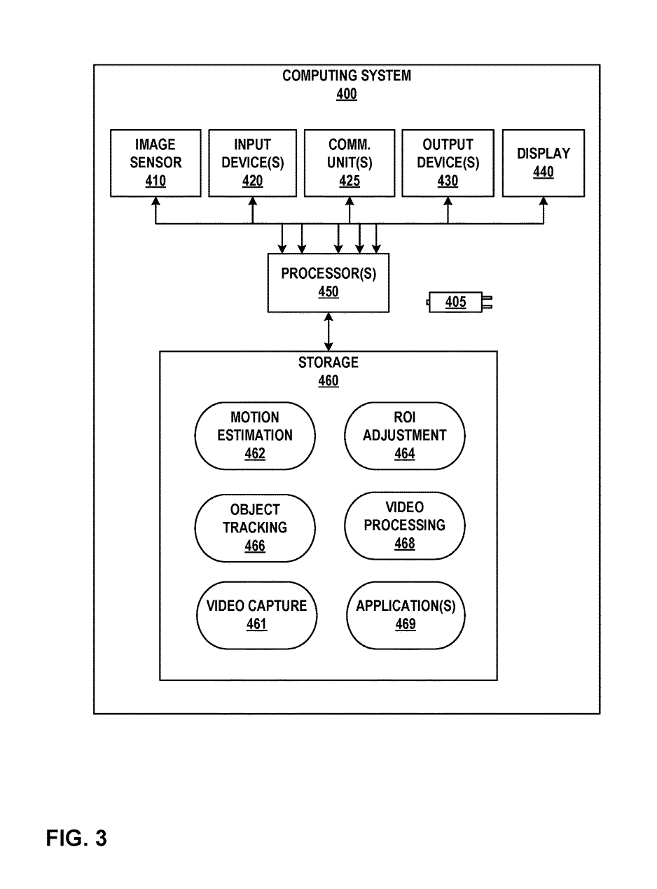

FIG. 3 is a block diagram illustrating an example computing system that is configured to track an object in video frames of a video sequence in accordance with one or more aspects of the present disclosure. Computing system 400 of FIG. 3 is described below as an example or alternate implementation of video processing system 10 of FIG. 1. However, FIG. 3 illustrates only one particular example or alternate implementation of video processing system 10, and many other example or alternate implementations of video processing system 10 may be used or may be appropriate in other instances. Such implementations may include a subset of the components included in the example of FIG. 3 or may include additional components not shown in the example of FIG. 3.

Computing system 400 of FIG. 3 includes power source 405, one or more image sensors 410, one or more input devices 420, one or more communication units 425, one or more output devices 430, display component 440, one or more processors 450, and one or more storage devices 460. In the example of FIG. 3, computing system 400 may be any type of computing device, such as a camera, mobile device, smart phone, tablet computer, laptop computer, computerized watch, server, appliance, workstation, or any other type of wearable or non-wearable, or mobile or non-mobile computing device that may be capable of operating in the manner described herein. Although computing system 400 of FIG. 3 may be a stand-alone device, computing system 400 may, generally, take many forms, and may be, or may be part of, any component, device, or system that includes a processor or other suitable computing environment for processing information or executing software instructions.

Image sensor 410 may generally refer to an array of sensing elements used in a camera that detect and convey the information that constitutes an image, a sequence of images, or a video. In some cases, image sensor 410 may include, but is not limited to, an array of charge-coupled devices (CCD), active pixel sensors in complementary metal-oxide-semiconductor (CMOS) devices, N-type metal-oxide-semiconductor technologies, or other sensing elements. Any appropriate device whether now known or hereafter devised that is capable of detecting and conveying information constituting an image, sequence of images, or a video may appropriately serve as image sensor 410.

One or more input devices 420 of computing system 400 may generate, receive, or process input. Such input may include input from a keyboard, pointing device, voice responsive system, video camera, button, sensor, mobile device, control pad, microphone, presence-sensitive screen, network, or any other type of device for detecting input from a human or machine.

One or more output devices 430 may generate, receive, or process output. Examples of output are tactile, audio, visual, and/or video output. Output device 430 of computing system 400 may include a display, sound card, video graphics adapter card, speaker, presence-sensitive screen, one or more USB interfaces, video and/or audio output interfaces, or any other type of device capable of generating tactile, audio, video, or other output.

One or more communication units 425 of computing system 400 may communicate with devices external to computing system 400 by transmitting and/or receiving data, and may operate, in some respects, as both an input device and an output device. In some examples, communication units 425 may communicate with other devices over a network. In other examples, communication units 425 may send and/or receive radio signals on a radio network such as a cellular radio network. In other examples, communication units 425 of computing system 400 may transmit and/or receive satellite signals on a satellite network such as a Global Positioning System (GPS) network. Examples of communication units include a network interface card (e.g. such as an Ethernet card), an optical transceiver, a radio frequency transceiver, a GPS receiver, or any other type of device that can send and/or receive information. Other examples of communication units 425 may include Bluetooth®, GPS, 3G, 4G, and Wi-Fi® radios found in mobile devices as well as Universal Serial Bus (USB) controllers and the like.

Display component 440 may function as one or more output (e.g., display) devices using technologies including liquid crystal displays (LCD), dot matrix displays, light emitting diode (LED) displays, organic light-emitting diode (OLED) displays, e-ink, or similar monochrome or color displays capable of generating tactile, audio, and/or visual output.

In some examples, including where computing system 400 is implemented as a smartphone or mobile device, display component 440 may include a presence-sensitive panel, which may serve as both an input device and an output device. A presence-sensitive panel may serve as an input device where it includes a resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology. A presence-sensitive panel may serve as an output or display device when it includes a display component. Accordingly, a presence-sensitive panel or similar device may both detect user input and generate visual and/or display output, and therefore may serve as both an input device and an output device.

While illustrated as an internal component of computing system 400, if display component 440 includes a presence-sensitive display, such a display may be implemented as an external component that shares a data path with computing system 400 for transmitting and/or receiving input and output. For instance, in one example, a presence-sensitive display may be implemented as a built-in component of computing system 400 located within and physically connected to the external packaging of computing system 400 (e.g., a screen on a mobile phone). In another example, a presence-sensitive display may be implemented as an external component of computing system 400 located outside and physically separated from the packaging or housing of computing system 400 (e.g., a monitor, a projector, etc. that shares a wired and/or wireless data path with computing system 400).

Power source 405 may provide power to one or more components of computing system 400. Power source 405 may receive power from the primary alternative current (AC) power supply in a building, home, or other location. In other examples, power source 405 may be a battery. In still further examples, computing system 400 and/or power source 405 may receive power from another source.

One or more processors 450 may implement functionality and/or execute instructions associated with computing system 400. Examples of processors 450 include microprocessors, application processors, display controllers, auxiliary processors, one or more sensor hubs, and any other hardware configured to function as a processor, a processing unit, or a processing device. Computing system 400 may use one or more processors 450 to perform operations in accordance with one or more aspects of the present disclosure using software, hardware, firmware, or a mixture of hardware, software, and firmware residing in and/or executing at computing system 400.

One or more storage devices 460 within computing system 400 may store information for processing during operation of computing system 400. In some examples, one or more storage devices 460 are temporary memories, meaning that a primary purpose of the one or more storage devices is not long-term storage. Storage devices 460 on computing system 400 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 460, in some examples, also include one or more computer-readable storage media. Storage devices 460 may be configured to store larger amounts of information than volatile memory. Storage devices 460 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Storage devices 460 may store program instructions and/or data associated with one or more of the modules described in accordance with one or more aspects of this disclosure.

One or more processors 450 and one or more storage devices 460 may provide an operating environment or platform for one or one more modules, which may be implemented as software, but may in some examples include any combination of hardware, firmware, and software. One or more processors 450 may execute instructions and one or more storage devices 460 may store instructions and/or data of one or more modules. The combination of processors 450 and storage devices 460 may retrieve, store, and/or execute the instructions and/or data of one or more applications, modules, or software. Processors 450 and/or storage devices 460 may also be operably coupled to one or more other software and/or hardware components, including, but not limited to, one or more of the components illustrated in FIG. 3.

One or more motion estimation modules 462 may operate to estimate motion information for one or more input video frames 200 in accordance with one or more aspects of the present disclosure. In some examples, motion estimation module 462 may include a codec to decode previously encoded video data to obtain motion vectors, or may implement algorithms used by a codec, e.g., on pixel domain video data, to determine motion vectors. For example, motion estimation module 462 may obtain motion vectors from decoded video data, or by applying a motion estimation algorithm to pixel domain video data obtained by image sensor 410 or retrieved from a video archive, or by applying a motion estimation algorithm to pixel domain video data reconstructed by decoding video data.

One or more ROI adjustment modules 464 may operate to adjust a ROI in a video frame based on motion information, such as the motion information estimated or determined by motion estimation module 462. In some examples, ROI adjustment module 464 may determine a ROI for a video frame based on both a ROI in a prior frame and motion information derived from the prior video frame and a subsequent video frame. Examples of adjustments to the ROI may include moving the ROI location and/or resizing the ROI.

One or more object tracking modules 466 may implement or perform one or more algorithms to track an object in video frames of a video sequence. In some examples, object tracking module 466 may implement a mean shift or a CAMShift algorithm, where the algorithm detects an object and/or determines a ROI based on an adjusted ROI.

One or more video processing modules 468 may process video frames of a video sequence in conjunction with information and/or ROI information about an object being tracked. Video processing module 468 may determine the trajectory, velocity, and/or distance traveled by a tracked object. Video processing module 468 may generate new output video frames 300 of a video sequence by annotating input video frames 200 to include one or more graphical images to identify an object or information about its motion, path, or other attributes. Video processing module 468 may encode video frames of a video sequence by applying preferential coding algorithms to the object being tracked, which may result in a higher quality images and/or video of the tracked object in decoded video frames of a video sequence.

Video capture module 461 may operate to detect and process images and/or video frames captured by image sensor 410. Video capture module 461 may process one or more video frames of a video sequence, and/or store such video frames in storage device 460. Video capture module 461 may also output one or more video frames to other modules for processing.

One or more applications 469 may represent some or all of the other various individual applications and/or services executing at and accessible from computing system 400. For example, applications 469 may include a user interface module, which may receive information from one or more input devices 420, and may assemble the information received into a set of one or more events, such as a sequence of one or more touch, gesture, panning, typing, pointing, clicking, voice command, motion, or other events. The user interface module may act as an intermediary between various components of computing system 400 to make determinations based on input detected by one or more input devices 420. The user interface module may generate output presented by display component 440 and/or one or more output devices 430. The user interface module may also receive data from one or more applications 469 and cause display component 440 to output content, such as a graphical user interface. A user of computing system 400 may interact with a graphical user interface associated with one or more applications 469 to cause computing system 400 to perform a function. Numerous examples of applications 469 may exist and may include video generation and processing modules, velocity, distance, trajectory, and analytics processing or evaluation modules, video or camera tools and environments, network applications, an internet browser application, or any and all other applications that may execute at computing system 400.

Although certain modules, components, programs, executables, data items, functional units, and/or other items included within storage device 460 may have been illustrated separately, one or more of such items could be combined and operate as a single module, component, program, executable, data item, or functional unit. For example, one or more modules may be combined or partially combined so that they operate or provide functionality as a single module. Further, one or more modules may operate in conjunction with one another so that, for example, one module acts as a service or an extension of another module. Also, each module, component, program, executable, data item, functional unit, or other item illustrated within storage device 460 may include multiple components, sub-components, modules, sub-modules, and/or other components or modules not specifically illustrated. Further, each module, component, program, executable, data item, functional unit, or other item illustrated within storage device 460 may be implemented in various ways. For example, each module, component, program, executable, data item, functional unit, or other item illustrated within storage device 460 may be implemented as a downloadable or pre-installed application or “app.” In other examples, each module, component, program, executable, data item, functional unit, or other item illustrated within storage device 460 may be implemented as part of an operating system executed on computing system 400.

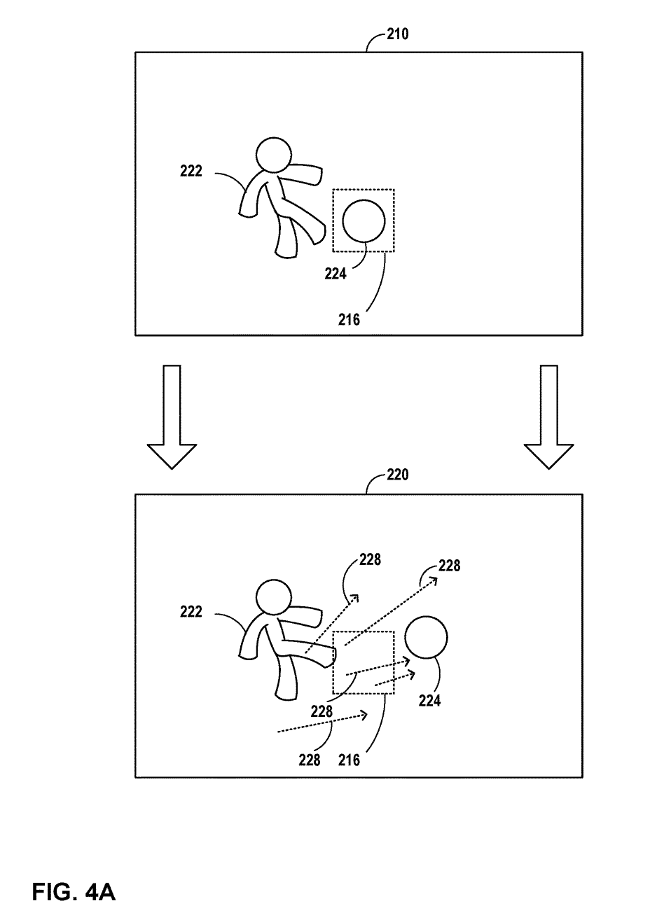

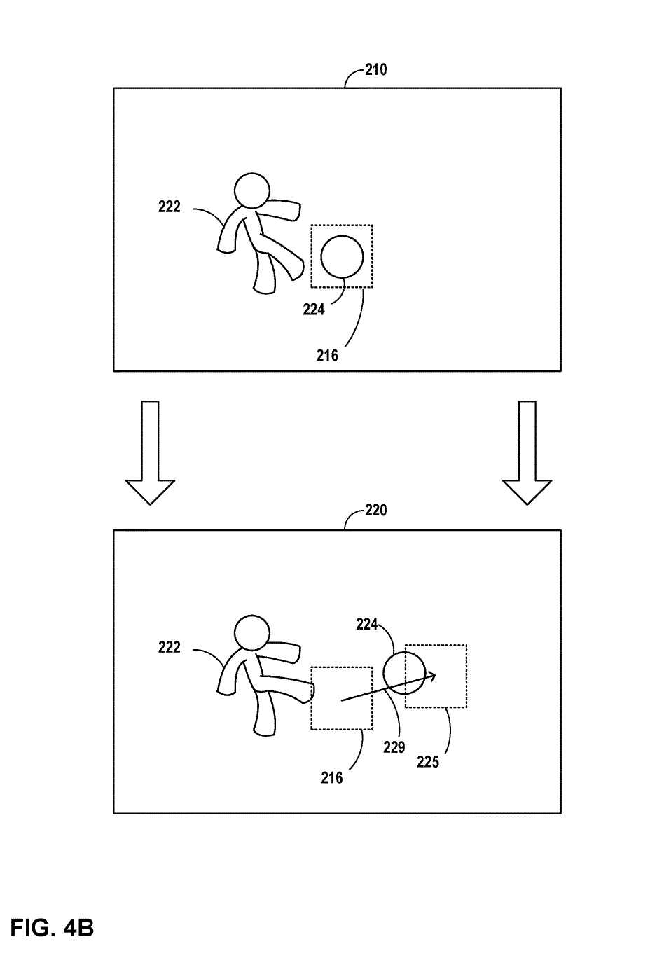

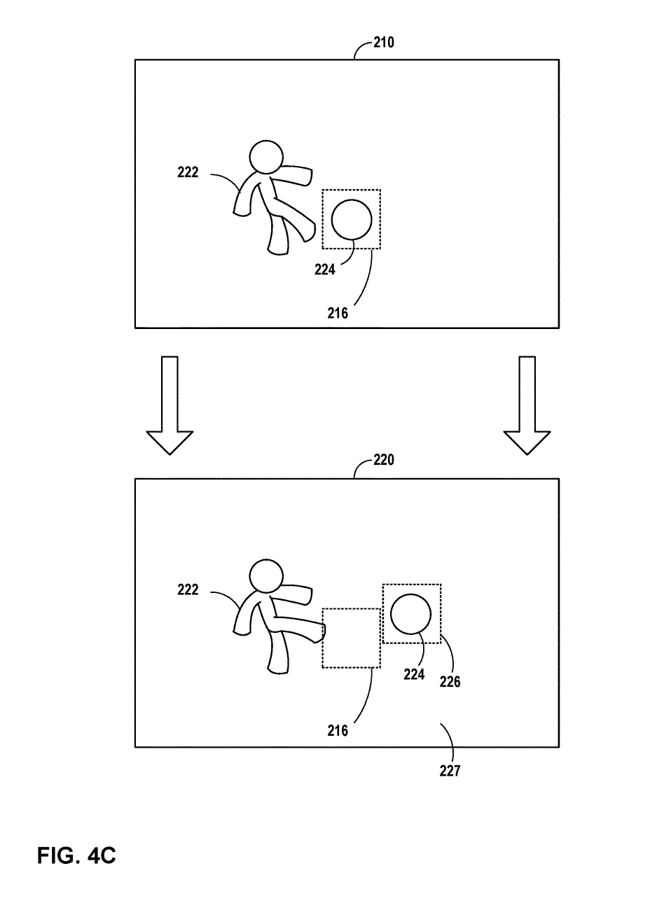

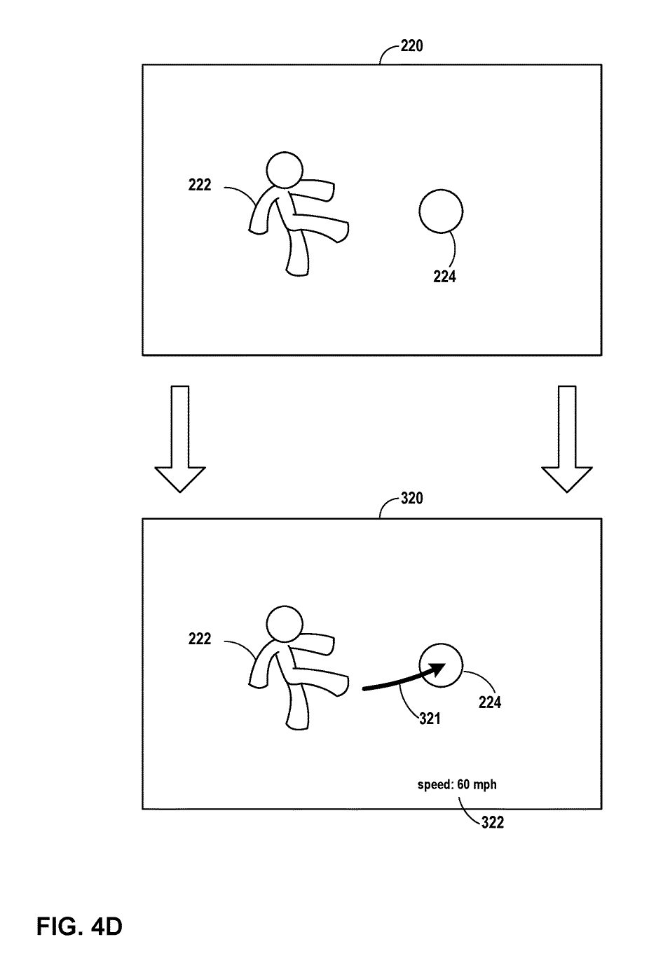

FIG. 4A, FIG. 4B, FIG. 4C, and FIG. 4D are conceptual diagrams illustrating example video frames of a video sequence, where a relatively fast object is tracked in accordance with one or more aspects of the present disclosure. The example(s) illustrated by FIG. 4A, FIG. 4B, FIG. 4C, and FIG. 4D depict video frame 210 and video frame 220, and show or describe example operations for tracking ball 224 in video frame 220. For purposes of illustration, one or more aspects of FIG. 4A, FIG. 4B, FIG. 4C, and FIG. 4D are described below within the context of computing system 400 of FIG. 3.

In FIG. 4A, computing system 400 of FIG. 3 may track an object in video frames of a video sequence. For example, image sensor 410 of computing system 400 may detect input, and image sensor 410 may output to video capture module 461 an indication of input. Video capture module 461 may determine, based on the indication of input, that the input corresponds to input video frames 200. Video capture module 461 may determine that input video frames 200 include video frame 210 and video frame 220, and video capture module 461 may determine that video frame 210 and video frame 220 are consecutive frames in the example of FIG. 4A. In the example shown, computing system 400 has previously determined ROI 216 identifying ball 224 in video frame 210.

Video capture module 461 may output to motion estimation module 462 information about video frame 210 and video frame 220, and motion estimation module 462 may determine or estimate motion information between video frame 210 and video frame 220. For example, motion estimation module 462 may determine or one or more motion vectors 228, as illustrated in video frame 220 of FIG. 4A. Motion vectors 228 describe or illustrate motion occurring between one or more coding units of video frame 210 and video frame 220. Motion vectors 228 may be generated by, for example, motion estimation module 462, or in other examples, motion vectors 228 may be derived from previously coded information. Motion vectors 228 may indicate movement, between frames, from a first block of video data in a first frame to a second block of video data in a second frame, where the first and second blocks are substantially similar to one another in terms of content, e.g., as determined by a sum of absolute difference (SAD), sum of squared difference (SSD), or other similarity metric applied in a motion search algorithm (i.e., a search in the second frame for blocks that substantially match the block in the first frame). The motion vectors can be determined directly (in the pixel domain before the video data is encoded) or they can be determined by decoding motion vectors from previously encoded video data.

Motion estimation module 462 may aggregate, average, or otherwise combine motion vectors 228 to determine composite motion vector 229, as illustrated in video frame 220 of FIG. 4B. The composite motion vector is determined by averaging the sum of x and y offset of the related motion vectors. Each motion vector may comprise an x component that indicates movement in an x direction and a y component that indicates movement in a y direction. The movement may be determined from a center of a first block of video data in a first frame to a center of a corresponding, (e.g., closely matching) second block in a second frame. Alternatively, the movement may be determined between other coordinates of the first and second blocks, such as corner coordinates of the blocks. In some examples, composite motion vector 229 may represent an averaging of motion vectors 228 of a plurality of blocks associated with the ROI in the first frame to determine a single motion vector with an x and y offset within video frame 220 corresponding to motion vectors 228. In other examples, motion estimation module 462 may select the dominant motion vector among the motion vectors 228. In some examples, motion estimation module 462 may identify the dominant motion vector by creating a histogram based on the direction of the related motion vectors and selecting the vector with the largest magnitude from the most common direction. Alternatively, a composite vector can be determined by only using the vectors from the most common direction. The plurality of blocks associated with the ROI in the first frame may include, in some examples, blocks that are inside the ROI, or blocks that are inside the ROI plus blocks that partially overlap with the ROI.

In some examples, composite motion vector 229 is determined based on a subset of motion vectors 228. For instance, in some examples, rather than considering or including all of the motion vectors 228 of the blocks associated with the ROI in performing calculations that result in composite motion vector 229, composite motion vector 229 may be determined based on only certain motion vectors 228. In some examples, motion estimation module 462 may use or include in calculations those motion vectors 228 that are more likely to result from the motion of the ball, rather than from the motion of other objects within video frame 220. In some examples, motion estimation module 462 might include one or more (or only those) motion vectors 228 for blocks that have any component or portion spanning ROI 216 in calculations resulting in a determination of composite motion vector 229. In another example, motion estimation module 462 might include one or more (or only those) motion vectors 228 that originate within ROI 216 in calculations resulting in a determination of composite motion vector 229. In other examples, motion estimation module 462 might include one or more (or only those) motion vectors 228 that also end within ROI 216 in calculations resulting in a determination of composite motion vector 229. In still further examples, motion estimation module 462 might include one or more (or only those) motion vectors 228 that are entirely within ROI 216 in calculations resulting in a determination of composite motion vector 229.

Motion estimation module 462 may output to ROI adjustment module 464 information about the motion determined by motion estimation module 462. In some examples, motion estimation module 462 may output to ROI adjustment module 464 information about composite motion vector 229. ROI adjustment module 464 may determine adjusted ROI 225, as shown in FIG. 4B, based on the motion information and/or composite motion vector 229 received from motion estimation module 462, and also based on information about ROI 216 from video frame 210. Specifically, in some examples, ROI adjustment module 464 may apply composite motion vector 229 as an offset to the position of ROI 216, thereby resulting in adjusted ROI 225. For example, ROI adjustment module 464 may apply the offset to the center of the ROI 216 or, in other examples, to a selected corner of ROI 216.

ROI adjustment module 464 may output to object tracking module 466 information sufficient to describe or derive adjusted ROI 225. Object tracking module 466 may apply a mean shift algorithm or a CAMShift algorithm to detect the location of ball 224. Object tracking module 466 may use adjusted ROI 225 as a starting ROI for the mean shift or CAMShift algorithm. Using adjusted ROI 225, object tracking module 466 may determine ROI 226, properly identifying ball 224, as shown in FIG. 4C.

Object tracking module 466 may output information about ball 224 and/or ROI 226 to video processing module 468 for further processing. For example, video processing module 468 may modify input video frames 220 and/or generate new output video frames 300 so that one or more output video frames 300 include information derived from object tracking information determined by computing system 400. For example, as shown in FIG. 4D, video processing module 468 may modify video frame 220 and superimpose or include trajectory arrow 321, resulting in new video frame 320, which illustrates the trajectory of ball 224. Alternatively, or in addition, video processing module 468 may superimpose or include velocity indicator 322 within video frame 320.

Although in the example described above, input video frames 200 originate from input detected by image sensor 410, in other examples, input video frames 200 may originate from another source. For example, video capture module 461 may receive input in the form input video frames 200 from storage device 460 as previously stored video frames of a video sequence, or video capture module 461 may receive input from one or more applications 469 that may generate video content. Other sources for input video frames 200 are possible.

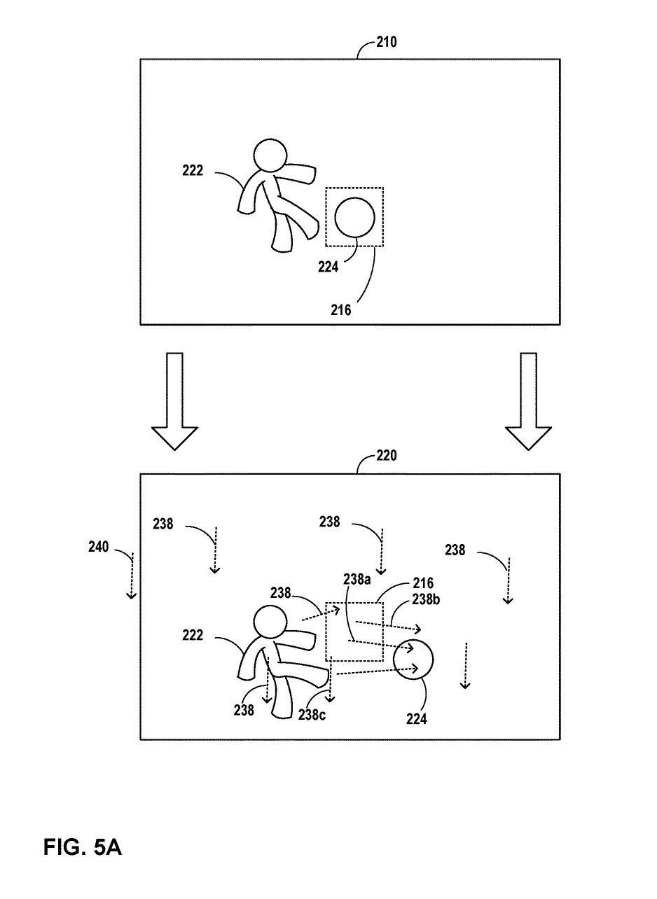

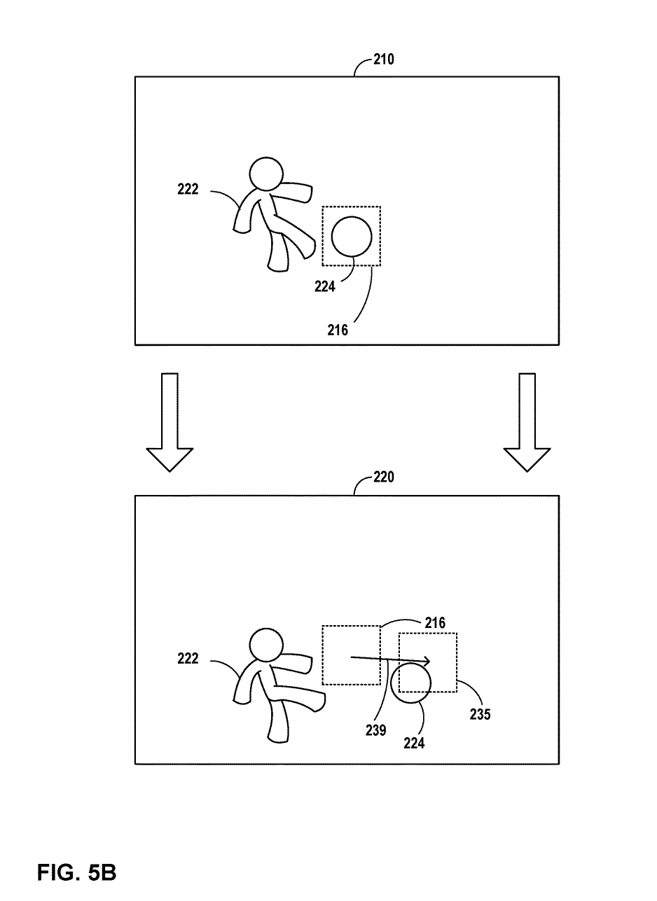

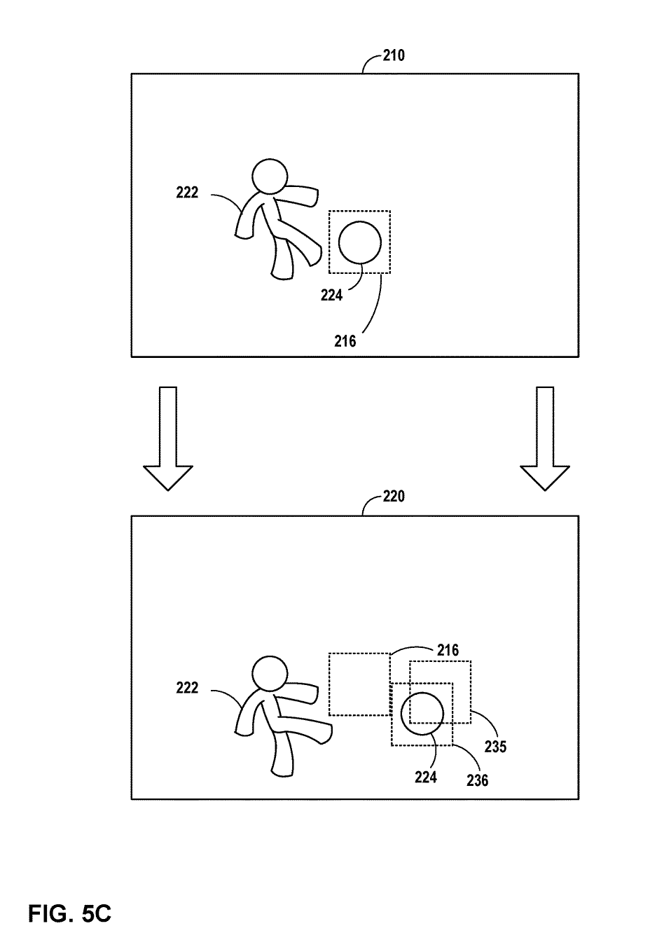

FIG. 5A, FIG. 5B, and FIG. 5C are conceptual diagrams illustrating example video frames of a video sequence, where a relatively fast object is tracked in a different example in accordance with one or more aspects of the present disclosure. The example of FIG. 5A, FIG. 5B, and FIG. 5C illustrates video frame 210 and video frame 220, and illustrates example operations for tracking ball 224 in video frame 220. For purposes of illustration, one or more aspects of FIG. 5A, FIG. 5B, and FIG. 5C are described below within the context of computing system 400 of FIG. 3.

In FIG. 5A, computing system 400 of FIG. 3 may track object ball 224 in a video frames of a video sequence, which may include video frame 210 and video frame 220. As in FIG. 4A, video capture module 461 may receive input that corresponds to input video frames 200, and video capture module 461 may output to motion estimation module 462 information about video frame 210 and video frame 220. Motion estimation module 462 may determine or estimate motion information between video frame 210 and video frame 220. In the example of FIG. 5A, ball 224 is moving to the right after having been kicked by soccer player 222, but in addition, the entire video frame 220 has also moved relative to video frame 210. The movement of the entire video frame 220 may be a result of physical movement of image sensor 410 and/or computing system 400 in an upward motion, resulting in video frame 220 exhibiting a downward-shifted perspective relative to that of video frame 210 of FIG. 5A. The movement of video frame 220 may alternatively be the result of a panning, zooming, or other operation performed by image sensor 410 or computing system 400.

As a result of the general downward motion affecting video frame 220 in FIG. 5A, video frame 220 includes a number of motion vectors 238 that point in a downward direction. These motion vectors 238 may represent objects or blocks of a frame where there was no actual motion, but because of movement of image sensor 410 or otherwise, motion was detected from the perspective of motion estimation module 462. In such cases, some motion vectors 238 may result entirely from global motion vector 240, which represents or corresponds to the general downward motion of the image depicted in video frame 220. Some or all of motion vectors 238 in video frame 220 may include a component of global motion vector 240. In some examples, global motion vector 240 is that component of motion that may apply to the entire video frame 220 due to effects or conditions that affect all of video frame 220.

Motion estimation module 462 may aggregate, average, or otherwise combine motion vectors 238 to determine composite motion vector 239, as illustrated in video frame 220 of FIG. 5B. In a manner similar to that described in FIG. 4A and FIG. 4B, motion estimation module 462 may determine composite motion vector 239 based on a subset of motion vectors 238. In the example of FIG. 5A, motion estimation module 462 determines composite motion vector 239 based on motion vectors 238 that originate within ROI 216. Of the motion vectors 238 illustrated in FIG. 5A, only motion vector 238a, motion vector 238b, and motion vector 238c originate within ROI 216. Motion estimation module 462 may further determine that the direction and magnitude of motion vector 238c is largely based on the general downward motion exhibited by many parts of video frame 220, or in other words, it is based largely on global motion vector 240. Based on this determination, motion estimation module 462 might determine that motion vector 238c should be given less weight or ignored when performing an averaging of motion vector 238a, motion vector 238b, and motion vector 238c. In general, motion estimation module 462 may determine that motion vectors 238 that match or are similar to global motion vector 240 and/or general motion exhibited by many other parts of video frame 220 should be given less weight, because such motion vectors 238 might not represent any actual movement of an object within video frame 220, but rather, may simply represent movement that corresponds to global motion vector 240 applying to the entire video frame 220. By ignoring motion vector 238c in the example of FIG. 5A, motion estimation module 462 may determine a more accurate composite motion vector 239.

Motion estimation module 462 may output to ROI adjustment module 464 information about composite motion vector 239. ROI adjustment module 464 may determine, based on composite motion vector 239 and ROI 216, adjusted ROI 235. ROI adjustment module 464 may output to object tracking module 466 information sufficient to describe or derive adjusted ROI 235. Such information may include coordinates of ROI 235 or may include offset information that object tracking module 466 may apply to ROI 216 to determine ROI 235. Object tracking module 466 may apply a CAMShift algorithm to detect the location of ball 224, and using adjusted ROI 235 as a starting ROI for the CAMShift algorithm, object tracking module 466 may determine ROI 236 in FIG. 5C. ROI 236 properly identifies the location of ball 224, as shown in FIG. 5C.

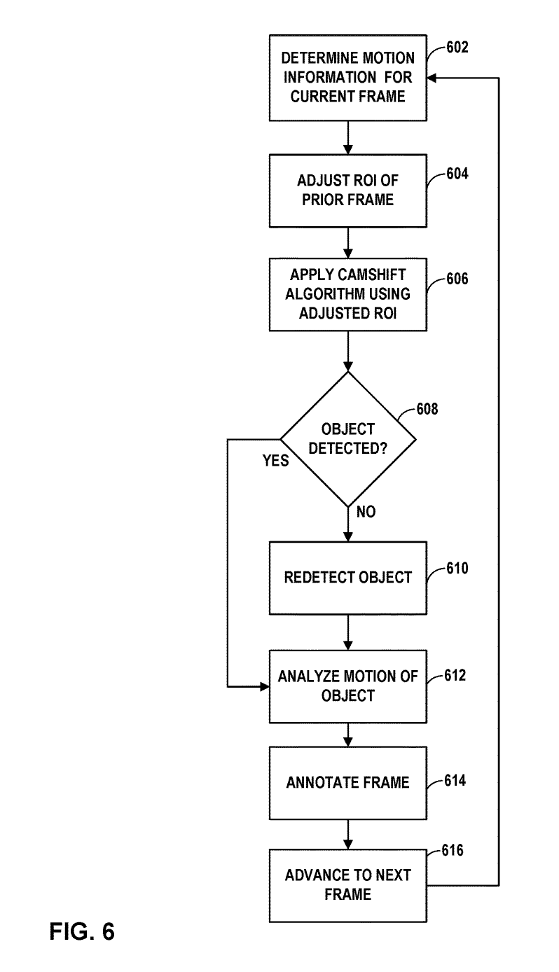

FIG. 6 is a flow diagram illustrating operations performed by an example computing system in accordance with one or more aspects of the present disclosure. FIG. 6 is described below within the context of computing system 400 of FIG. 3 and input video frames 200, including video frame 210 and video frame 220. In other examples, operations described in connection with FIG. 6 may be performed by one or more other components, modules, systems, or devices. Further, in other examples, operations described in connection with FIG. 6 may be merged, performed in a difference sequence, or omitted.

In the example of FIG. 6, motion estimation module 462 may determine motion information for a current frame relative to a prior frame (602). For example, motion estimation module 462 may determine information describing motion between video frame 210 and video frame 220, which may be in the form of motion vectors. Motion estimation module 462 may determine information describing motion for only a portion of the video frames 210 and 220, because it might not be necessary to determine motion across the entire frame. Motion estimation module 462 may select a subset of motion vectors, based on those motion vectors likely to represent motion by the object being tracked. Motion estimation module 462 may determine a composite motion vector.

ROI adjustment module 464 may adjust the ROI for prior frame video frame 210 based on the composite motion vector (604). ROI adjustment module 464 may have stored information about the ROI for prior video frame 210 in storage device 460 when processing prior video frame 210. ROI adjustment module 464 may adjust this ROI by using the composite motion vector as an offset. For example, ROI adjustment module 464 may apply the offset from the center of ROI 216 to determine a new ROI. In another example, ROI adjustment module may apply the offset from another location of the ROI, such as a corner or other convenient location.

Object tracking module 466 may apply a CAMShift algorithm to detect the object being tracked in video frame 220, based on the adjusted ROI determined by ROI adjustment module 464 (606). The CAMShift algorithm may normally attempt to detect the location of the object being tracked by using the unadjusted ROI from video frame 210, but in accordance with one or more aspects of the present disclosure, object tracking module 466 may apply the CAMShift algorithm using the adjusted ROI determined by ROI adjustment module 464. In some examples, this modification enables the CAMShift algorithm to more effectively track fast-moving objects.

If object tracking module 466 successfully tracks the object in video frame 220 (YES path from 608), object tracking module 466 may output to video processing module 468 information about the object being tracked and/or the ROI determined by object tracking module 466. If object tracking module 466 does not successfully track the object in video frame 220 (NO path from 608), object tracking module 466 may redetect the object (610), and then output to video processing module 468 information about the object being tracked and/or the ROI determined by object tracking module 466.

Video processing module 468 may, based on input video frames 200 and the information received from object tracking module 466, analyze the motion of the object being tracked (612). Video processing module 468 may annotate and or modify one or more input video frames 200 to include information about the object being tracked (e.g., trajectory, velocity, distance) and may generate a new video frame 320 (614). Computing system 400 may apply the process illustrated in FIG. 6 to additional input video frames 200 in the video sequence (616).

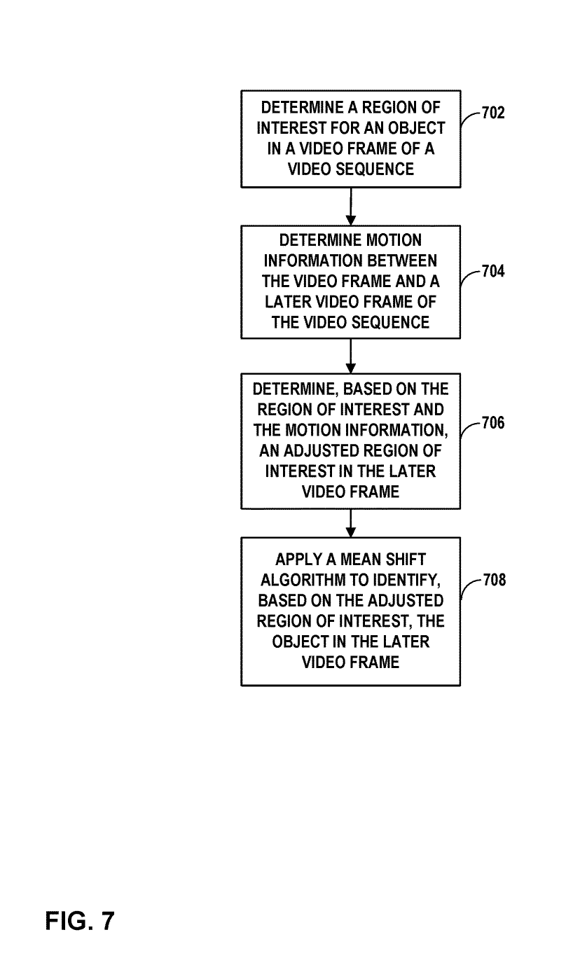

FIG. 7 is a flow diagram illustrating an example process for performing object tracking in accordance with one or more aspects of the present disclosure. The process of FIG. 7 may be performed by ROI processor 100 as illustrated in FIG. 1. In other examples, operations described in connection with FIG. 7 may be performed by one or more other components, modules, systems, and/or devices. Further, in other examples, operations described in connection with FIG. 7 may be merged, performed in a difference sequence, or omitted.

In the example of FIG. 7, ROI processor 100 may determine a ROI for an object in a video frame of a video sequence (702). For example, ROI processor 100 may apply an object tracking algorithm (e.g., a CAMShift algorithm) to determine a ROI. In another example, ROI processor 100 may detect input that it determines corresponds to selection of an object within the frame of video. ROI processor 100 may determine a ROI corresponding to, or based on, the input.

ROI processor 100 may determine motion information between the video frame and a later video frame of the video sequence (704). For example, motion estimation circuitry 102 of ROI processor 100 may measure motion information between the video frame and the later frame by applying algorithms similar to or the same as those applied by a video coder for inter-picture prediction.

ROI processor 100 may determine, based on the ROI and the motion information, an adjusted ROI in the later video frame (706). For example, ROI adjustment circuitry 104 of ROI processor 100 may evaluate the motion information determined by motion estimation circuitry 102 and determine a composite motion vector that is based on motion information that is relatively likely to apply to the motion of the object to be tracked. ROI adjustment circuitry 104 may move the location of the ROI by offsetting the ROI in the direction of the composite motion vector.

ROI processor 100 may apply a mean shift algorithm to identify, based on the adjusted ROI, the object in the later video frame (708). For example, object tracking circuitry 106 may perform operations consistent with the CAMShift algorithm to detect the object in the later video frame based on the adjusted ROI determined by ROI adjustment circuitry 104.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically might be alternatively not performed automatically, but rather, such operations, acts, steps, or events might be, in some examples, performed in response to input or another event.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. A method comprising:
determining a region of interest for an object in a first video frame of a video sequence;
determining motion information indicating motion between at least a portion of the first video frame and at least a portion of a second video frame of the video sequence;
determining, based on the region of interest and the motion information, an adjusted region of interest in the second video frame; and
applying a mean shift algorithm to identify, based on the adjusted region of interest, the object in the second video frame.

2. The method of claim 1, wherein applying the mean shift algorithm comprises:
applying a CAMShift algorithm.

3. The method of claim 1,
wherein determining motion information comprises determining a plurality of motion vectors; and
wherein determining the adjusted region of interest comprises determining, based on the plurality of motion vectors, the adjusted region of interest in the second video frame.

4. The method of claim 1,
wherein determining motion information comprises determining a plurality of motion vectors originating within the region of interest of the first frame; and
wherein determining the adjusted region of interest comprises determining, based on the plurality of motion vectors originating within the region of interest, the adjusted region of interest in the second video frame.

5. The method of claim 1,
wherein determining the adjusted region of interest comprises determining, based only on motion vectors originating within the region of interest of the first frame, the adjusted region of interest in the second video frame.

6. The method of claim 1,
wherein determining motion information comprises determining a global motion vector and a plurality of motion vectors; and
wherein determining the adjusted region of interest comprises determining, based on the global motion vector and the plurality of motion vectors, the adjusted region of interest in the second video frame.

7. The method of claim 1, further comprising:
determining analytic information about movement of the object; and
annotating a plurality of video frames of the video sequence to include the analytic information.

8. A video processing system comprising:
one or more storage devices configured to store data representing a video sequence; and
one or more processors configured to:
determine a region of interest for an object in a first video frame of a video sequence,
determine motion information indicating motion between at least a portion of the first video frame and at least a portion of a second video frame of the video sequence,
determine, based on the region of interest and the motion information, an adjusted region of interest in the second video frame, and
apply a mean shift algorithm to identify, based on the adjusted region of interest, the object in the second video frame.

9. The video processing system of claim 8, wherein to apply the mean shift algorithm, the one or more processors are further configured to:
apply a CAMShift algorithm.

10. The video processing system of claim 8,
wherein determining motion information comprises determining a plurality of motion vectors; and
wherein determining the adjusted region of interest comprises determining, based on the plurality of motion vectors, the adjusted region of interest in the second video frame.

11. The video processing system of claim 8,
wherein determining motion information comprises determining a plurality of motion vectors originating within the region of interest of the first frame; and
wherein determining the adjusted region of interest comprises determining, based on the plurality of motion vectors originating within the region of interest, the adjusted region of interest in the second video frame.

12. The video processing system of claim 8,
wherein determining the adjusted region of interest comprises determining, based only on motion vectors originating within the region of interest of the first frame, the adjusted region of interest in the second video frame.

13. The video processing system of claim 8,
wherein determining motion information comprises determining a global motion vector and a plurality of motion vectors; and
wherein determining the adjusted region of interest comprises determining, based on the global motion vector and the plurality of motion vectors, the adjusted region of interest in the second video frame.

14. The video processing system of claim 8, wherein the one or more processors are further configured to:
determine analytic information about movement of the object; and
annotate a plurality of video frames of the video sequence to include the analytic information.

15. A computer-readable storage medium storing instructions that, when executed, cause at least one processor of a computing system to:
determine a region of interest for an object in a first video frame of a video sequence;
determine motion information indicating motion between at least a portion of the first video frame and at least a portion of a second video frame of the video sequence;
determine, based on the region of interest and the motion information, an adjusted region of interest in the second video frame; and
apply a mean shift algorithm to identify, based on the adjusted region of interest, the object in the second video frame.

16. The computer-readable storage medium of claim 15, wherein applying a mean shift algorithm comprises:
applying a CAMShift algorithm.

17. The computer-readable storage medium of claim 15,
wherein determining motion information comprises determining a plurality of motion vectors; and
wherein determining the adjusted region of interest comprises determining, based on the plurality of motion vectors, the adjusted region of interest in the second video frame.

18. The computer-readable storage medium of claim 15,
wherein determining motion information comprises determining a plurality of motion vectors originating within the region of interest of the first frame; and
wherein determining the adjusted region of interest comprises determining, based on the plurality of motion vectors originating within the region of interest, the adjusted region of interest in the second video frame.

19. The computer-readable storage medium of claim 15,
wherein determining the adjusted region of interest comprises determining, based only on motion vectors originating within the region of interest, the adjusted region of interest in the second video frame.

20. The computer-readable storage medium of claim 15,
wherein determining motion information comprises determining a global motion vector and a plurality of motion vectors; and
wherein determining the adjusted region of interest comprises determining, based on the global motion vector and the plurality of motion vectors, the adjusted region of interest in the second video frame.
